(19) United States
(12) Patent Application Publication
(10) Pub. No.: US 2016/0132831 A1
(43) Pub. Date: May 12, 2016

(54) SYSTEM AND METHOD FOR HUMAN RESOURCE MANAGEMENT

(71) Applicant: Xerox Corporation, Norwalk, CT (US)

(72) Inventors: Avinash Sharma, Bangalore (IN); Partha Dutta, Bangalore (IN); Jyotirmaya Mahapatra, Odisha (IN); Abhishek Tripathi, Bangalore (IN)

(21) Appl. No.: 14/535,359

(22) Filed: Nov. 7, 2014

(51) Int. Cl. G06Q 10/10

(52) U.S. Cl. CPC G06Q 10/1053

(57) ABSTRACT

The disclosed embodiments illustrate methods and systems for human resource management in an organization. A graph, representative of relationships between employees, job openings, and candidates applied for the job openings, is generated. The graph is transformed to generate a graph matrix deterministic of a mapping of nodes depicted in the graph, in a predetermined dimensional space. Further, a first distance between nodes corresponding to the candidates and a node corresponding to a job opening is determined based on the graph matrix. A list of ranked candidates, based on the first distance, is presented over a display associated with a hiring manager, allowing selection of a set of candidates. Additionally, a second distance between nodes corresponding to the candidates and between each node corresponding to a candidate and each node corresponding to an employee, is determined, based on which a set of candidates for a team are selected.

### TECHNICAL FIELD

The presently disclosed embodiments are related, in general, to human resource management systems. More particularly, the presently disclosed embodiments are related to methods and systems for talent acquisition in an organization.

### BACKGROUND

Current organizations in market offer myriad and complex products and services. To support these services, high level of intra-team coordination within appropriate operations teams may be required. However, a human resource team, in the current organization, may encounter challenges in acquiring suitable talent for such teams. One of the challenges that the human resource team may face is attrition rate in the organization. In order to counter the attrition rate (so that the work in the organization is not hampered), the human resource team may have to recruit people in the organization.

Usually the human resource team may hire a person based on job requirements/job description. The human resource team may not have taken into an account the cohesion of the person with existing team members. This may lead to other challenges such as, but are not limited to, setting of wrong expectations, and differences among the team members.

### SUMMARY

According to embodiments illustrated herein, there is provided a human resource management system. The human resource management system comprises one or more processors and a transceiver. The one or more processors are configured to generate a graph representative of at least a relationship between one or more entities corresponding to one or more employees associated with an organization, one or more job openings in the organization, and one or more candidates for the one or more job openings. Said one or more entities are depicted as one or more nodes in the graph. The one or more processors are further configured to transform the graph to generate a graph matrix deterministic of at least a mapping of each of the one or more nodes in a predetermined dimensional space. In addition, the one or more processors are configured to determine a first distance between a first set of nodes, corresponding to the one or more candidates, from the one or more nodes, and a second node, corresponding to a job opening from the one or more job openings, from the one or more nodes, based on the graph matrix. The one or more processors are configured to rank the one or more candidates based on the first distance. The transceiver is configured to transmit a list of the ranked one or more candidates to a computing device. Said computing device presents the ranked list of candidates over a display associated with the computing device.

According to embodiments illustrated herein, there is provided a method for selecting a set of candidates for a job opening in an organization. The method includes generating, by one or more processors, a graph representative of at least a relationship between one or more entities associated with the organization. Said one or more entities correspond to one or more employees, one or more job openings in said organization, and one or more candidates for said one or more job openings. Said one or more entities are depicted as one or more nodes in said graph. The method further includes transforming, by the one or more processors, the graph to generate a graph matrix. Said graph matrix is deterministic of at least a mapping of each of the one or more nodes in a predetermined dimensional space. In addition, the method involves determining, by the one or more processors, a first distance between a first set of nodes, corresponding to the one or more candidates, from the one or more nodes, and a second node, corresponding to the job opening from the one or more job openings, from the one or more nodes, based on the graph matrix. The method further involves ranking, by the one or more processors, the one or more candidates based on the first distance. The method includes transmitting, by a transceiver, a list of the ranked one or more candidates to a computing device, wherein the computing device presents the ranked list of candidates over a display associated with the computing device. In addition, the method includes receiving, by the transceiver, an input deterministic of selection of the set of candidates from the list of ranked one or more candidates.

According to embodiments illustrated herein, there is provided a method for selecting a set of candidates for a team in an organization. The method includes generating, by one or more processors, a graph representative of at least a relationship between one or more entities associated with the organization. Said one or more entities correspond to one or more employees, one or more job openings in the organization, and one or more candidates for the one or more job openings. Said one or more entities are depicted as one or more nodes in the graph. The method further includes transforming, by the one or more processors, the graph to generate a graph matrix. Said graph matrix is deterministic of at least a mapping of each of the one or more nodes in a predetermined dimensional space. The method involves determining, by the one or more processors, a second distance between the one or more candidates, and between each of the one or more candidates and each of the one or more employees. The method further involves receiving, by a transceiver, an input deterministic of a size of the team, wherein the team includes at least one employee from the one or more employees. In addition, the method includes identifying one or more sets of candidates based on the size of said team. The method involves determining, by the one or more processors, a second score for each of the one or more sets of candidates based on at least the second distance. The method further involves transmitting, by the transceiver, a list of ranked one or more sets of candidates to a computing device. Said computing device presents a ranked list of the one or more sets of candidates for the team, based on the second distance, over a display associated with the computing device. The method includes receiving, by the transceiver, an input deterministic of selection of the set of candidates from the ranked list of the one or more sets of candidates for the team.

According to embodiments illustrated herein, there is provided a computer program product for use with a computer, the computer program product comprising a non-transitory computer readable medium. Said non-transitory computer readable medium stores a computer program code for determining incentives for sharing one or more computational resources in a network. Said computer program code is executable by one or more processors to generate a graph representative of at least a relationship between one or more entities corresponding to one or more employees associated with an organization, one or more job openings in the organization, and one or more candidates for the one or more job openings. Said one or more entities are depicted as one or more nodes in said graph. Said computer program code is executable by the one or more processors to transform the graph to generate a graph matrix deterministic of at least a mapping of each of the one or more nodes in a predetermined dimensional space. Said computer program code is further executable by the one or more processors to determine a first distance between a first set of nodes, corresponding to the one or more candidates, from the one or more nodes, and a second node, corresponding to a job opening from the one or more job openings, from the one or more nodes, based on the graph matrix. In addition, said computer program code is executable by one or more processors to rank the one or more candidates based on the first distance.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented;

FIG. 2 is a block diagram of a computing device, in accordance with at least one embodiment;

FIG. 3 illustrates a flowchart for selecting a set of candidates for a job opening in an organization, in accordance with at least one embodiment;

FIG. 4 is a graph representing relationships between one or more entities associated with an organization, in accordance with at least one embodiment;

FIG. 5 illustrates a flowchart for selecting a set of candidates for a team in an organization, in accordance with at least one embodiment;

FIG. 6 is a depiction of a graphical user interface for selecting a set of candidates for a team in an organization, in accordance with at least one embodiment; and

FIG. 7 is a depiction of a graphical user interface for evaluating a selected set of candidates for a team in an organization, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example”, and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

### DEFINITIONS

The following terms shall have, for the purposes of this application, the meanings set forth below.

An “organization” refers to a group of people, who works together to achieve a predetermined goal. In an embodiment, the organization may include one or more teams that may further include one or more employees. Each of the one or more teams may have respective goals.

“One or more entities associated with an organization” refer to one or more employees of the organization, one or more job openings in the organization, and one or more candidates, who have applied for the one or more job openings in the organization.

“Job openings” refer to a vacancy in an organization that may be filled by a candidate. In an embodiment, one or more candidates may apply for a job opening.

“Job description” refers to a list of roles and responsibilities associated with the job opening in an organization. Further, the job description may include information pertaining to expected job responsibilities, expected qualification of the one or more candidates, minimum experience required, minimum expertise required, etc.

A “candidate profile” refers to information about a candidate. In an embodiment, the candidate profile may include information pertaining to education background, prior work experience, one or more skills, etc.

An “employee profile” refers to information about an employee of an organization. In an embodiment, the employee profile may include information pertaining to education background, prior work experience, one or more skills, tenure in the organization, associated one or more teams in the organization, one or more prior projects attempted or executed by the employee, etc.

“Social Connections” refer to a parameter that indicates common acquaintances over social media, between an employee and a candidate, between two candidates, and between two employees. In an embodiment, this parameter may be indicative of an information about an organization where a candidate and an employee may have worked together, therefore being more comfortable in working together in the current organization. In an embodiment, the social connection may further be indicative of an acquaintance between the candidate and the employee over social mediums such as Facebook®, and Linkedin®.

“Job affiliation” refers to a parameter that may be indicative of a relationship between two employees, who have worked together in past on a project or in a previous organization.

“Historical decisions” refer to the historical information pertaining to past performances of a candidate or an employee in an organization. In an embodiment, the information may further include the past performance of the candidate or the employee on projects that had similar requirements to that disclosed in the job description (of a job opening) under consideration.

A “graph” refers to a representation of one or more objects that are connected with each other through one or more edges. In an embodiment, the one or more edges are representative of a relationship between the one or more objects. In an embodiment, the one or more objects are represented as one or more nodes in the graph. In a scenario, where one or more entities associated with an organization is represented in the graph, the one or more entities form the one or more nodes in the graph. Further, a relationship among the one or more entities is represented by the one or more edges in the graph.

A “Graph matrix” refers to a data structure that is generated from the graph by mapping each of the one or more nodes in the graph to a K-dimensional space. In an embodiment, the graph matrix may be utilizable to determine a Euclidean distance between the nodes.

A “relationship” refers to a connection between the one or more objects in the graph. As discussed above, the graph for the organization may represent one or more entities associated with the organization as the one or more nodes. The relationship between the one or more entities is represented as the one or more edges in the graph. In an embodiment, the various types of relationships in the graph may include, but are not limited to, relationship between the one or more job openings, relationship between the one or more candidates, relationship between the one or more employees, relationship between the one or more candidates and the one or more job openings, relationship between the one or more employees and the one or more job openings, and relationship between the one or more candidates and the one or more employees.

A “first distance” refers to a measure of degree of similarity between profiles of one or more candidates (who have applied for one or more job openings in the organization) and job description of the one or more job openings in the organization. In an embodiment, the first distance may correspond to the Euclidean distance between the one or more nodes corresponding to the one or more candidates and the one or more nodes corresponding to the one or more job openings in the organization, based on the graph matrix. In further embodiment, the first distance corresponds to commute time distance (CTD) between the one or more nodes.

A “first score” refers to a score assigned to each of the one or more edges in the graph. In an embodiment, the first score may be indicative of a measure of degree of relationship/similarity between the one or more nodes in the graph.

A “second distance” refers to a Euclidean distance at least between one or more nodes corresponding to the one or more candidates, and between one or more nodes corresponding to each of the one or more candidates and between one or more nodes corresponding to each of the one or more employees.

A “second score” refers to a measure of degree of relationship/affinity among a set of candidates and the existing employees in a team in the organization, based on the second distance. In an embodiment, for one or more sets of candidates, corresponding one or more second scores may be determined. Based on the comparison between the one or more second scores, the one or more candidates may be selected for the team.

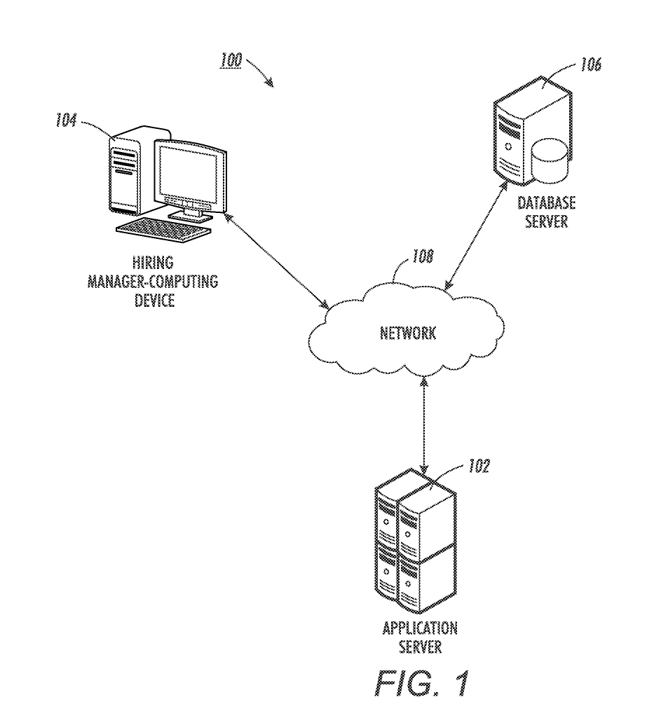

FIG. 1 is a block diagram of a system environment 100, in which various embodiments can be implemented. The system environment 100 includes an application server 102, a hiring manager-computing device 104, a database server 106, and a network 108.

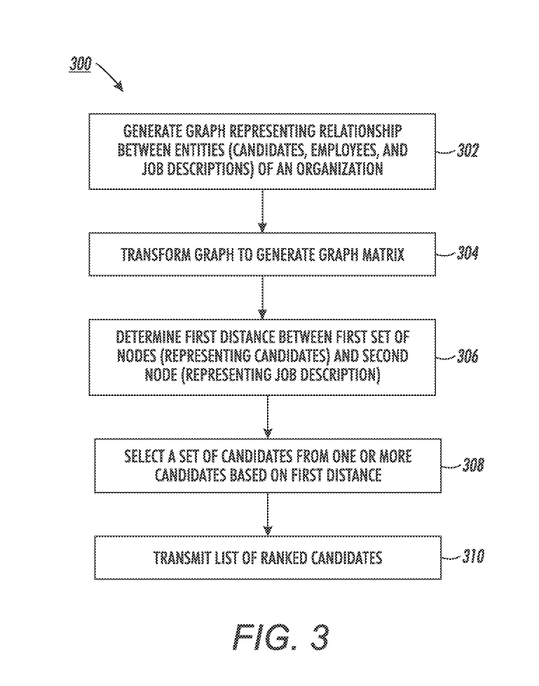

The application server 102 refers to a computing device configured to facilitate a hiring manager in selecting a set of candidates from one or more candidates for a job opening in an organization. In an embodiment, the application server 102 may generate a graph representative of relationships between the one or more candidates, one or more employees, and one or more job descriptions corresponding to the one or more job openings. In an embodiment, the relationships between the one or more entities of the organization may be representative of a similarity between the one or more entities of the organization. The application server 102 may extract the candidate profile information, the employee profile information, and the one or more job descriptions corresponding to the one or more job openings from the database server 106 to generate the graph. In an embodiment, the one or more candidates, the one or more employees, and the one or more job descriptions corresponding to the one or more job openings are represented as one or more nodes in the graph. The graph has been described later in conjunction with FIG. 3. Additionally, the application server 102 may transform the graph to generate a graph matrix. The graph matrix is representative of mapping of the one or more nodes in a predetermined dimensional space. The application server 102 may determine a first distance between a first set of nodes and a second node based on the graph matrix. The first set of nodes may correspond to the one or more candidates and the second node may correspond to a job opening under consideration. In an embodiment, the first distance may be indicative of a degree of similarity between the profile of the one or more candidates and the job opening. Based on the first distance, the application server 102 may rank the one or more candidates. Further, based on the ranking, the application server 102 may select the set of candidates from the one or more candidates. In an alternate embodiment, the application server 102 may present a list of ranked candidates to the hiring manager over a display associated with the hiring manager-computing device 104.

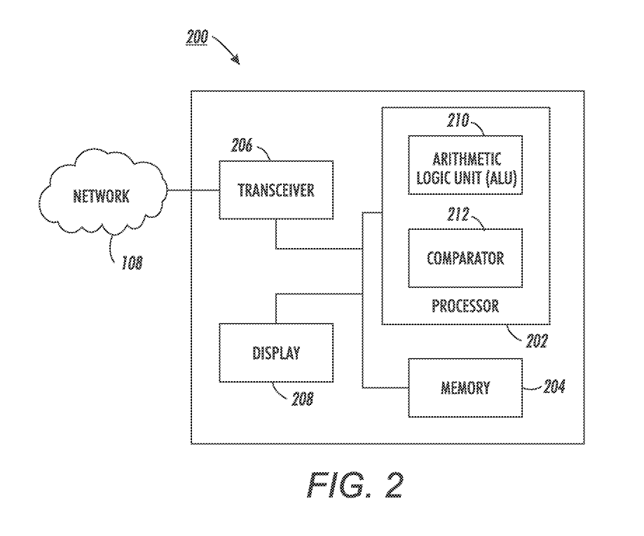

In an embodiment, the application server 102 may facilitate the hiring manager in selecting a set of candidates for a team in the organization. In this scenario, the application server 102 may determine a second distance between the first set of nodes (corresponding to the one or more candidates), and between each of the first set of nodes and each of a third set of nodes (corresponding to the one or more employees), based on the graph matrix. In an embodiment, the one or more employees correspond to team members of the team for which the one or more candidates are being considered. The application server 102 may identify one or more sets of candidates based on a size of the team provided by the hiring manager. Further, the application server 102 may determine a second score for each of the one or more sets of candidates based on the second distance. Based on the second score, the application server 102 may rank the one or more sets of candidates. Further, based on the ranking, the application server 102 may select the set of candidates from the one or more sets of candidates for the team. In an alternate embodiment, the application server 102 may present a list of ranked one or more sets of candidates to the hiring manager over a display associated with the hiring manager-computing device 104. The application server 102 has been described later in conjunction with FIG. 2. Further, the operation of the application server 102 has been described later in conjunction with FIG. 3. Some examples of the application server 102 may include, but are not limited to, a Java application server, a .NET framework, and a Base4 application server.

The hiring manager-computing device 104 refers to a computing device that may be utilized by a hiring manager to interact with the application server 102 for selecting a set of candidates for a job opening in the organization. In an embodiment, the hiring manager may require the set of candidates for the job opening associated with the team in the organization. In an embodiment, the hiring manager-computing device 104 may receive a user interface from the application server 102. The user interface may enable the hiring manager to input the one or more parameters based on which the set of candidates need to be selected. In an embodiment, the user interface may further display the information pertaining to the set of candidates that have been selected by the application server 102. In an alternate embodiment, the user interface may further display the information pertaining to the list of ranked candidates. In an embodiment, the user interface may correspond to a web interface that is receivable from the application server 102. In an alternate embodiment, the user interface may be of a software application installed in the hiring manager-computing device 104. In an embodiment, the software application may perform the functionalities of the application server 102 to select the set of candidates. In an embodiment, the hiring manager-computing device 104 may connect to the application server 102 over the network 108. Examples of the hiring manager-computing device 104 include, but are not limited to, a Smartphone, a laptop, a personal digital assistant (PDA), a tablet, a desktop computer, and the like.

The database server 106 is configured to store information pertaining to the profiles of one or more candidates, profiles of the one or more employees, and the job descriptions associated with the one or more job openings. The database server 106 may further store information related to social and professional connections associated with the one or more candidates, historical decisions, and job affiliations. In an embodiment, the database server 106 may receive a query from the application server 102 to extract/update the information. The database server 106 may be realized through various technologies such as, but not limited to, Microsoft® SQL server, Oracle, and My SQL. In an embodiment, the application server 102 may connect to the database server 106 using one or more protocols such as, but not limited to, Open Database Connectivity (ODBC) protocol and Java Database Connectivity (JDBC) protocol. The database server 106 may be implemented using technologies including, but not limited to, Oracle®, IBM DB2®, Microsoft SQL Server®, Microsoft Access®, PostgreSQL®, MySQL® and SQLite®, and the like.

A person with ordinary skill in the art would understand that the scope of the disclosure is not limited to the database server 106 as a separate entity. In an embodiment, the functionalities of the database server 106 can be integrated into the application server 102.

The network 108 corresponds to a medium through which content and messages flow between various devices of the system environment 100 (e.g., the application server 102, the hiring manager-computing device 104, and the database server 106). Examples of the network 108 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

FIG. 2 is a block diagram that illustrates a computing device 200, in accordance with at least one embodiment. In an embodiment, the computing device 200 may correspond to at least one of the application server 102, the hiring manager-computing device 104, or the database server 106. For the purpose of ongoing description, the computing device 200 is considered as the application server 102. However, the scope of the disclosure should not be limited to the computing device 200 as the application server 102. The computing device 200 can also be realized as the hiring manager-computing device 104 or the database server 106.

The computing device 200 includes a processor 202, a memory 204, a transceiver 206, and a display screen 208. The processor 202 is coupled to the memory 204, the transceiver 206, and the display screen 208. The transceiver 206 is connected to the network 108.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application-Specific Integrated Circuit (ASIC) processor, a Complex Instruction Set Computing (CISC) processor, or any other processor. In addition, the processor 202 may include an arithmetic logic unit (ALU) 210 and a comparator 212.

The arithmetic logic unit (ALU) 210 may include suitable logic, circuitry, and/or interfaces that may be operable to perform integer/floating-point arithmetic and logical operations on data. In an embodiment, the digital circuitry may include one or more logic gates (AND, OR, NAND, etc.) that may be coupled with each other in a predetermined manner to create the digital circuitry. Further, a person having ordinary skill in the art would understand that the arithmetic logic unit (ALU) 210 may correspond to a SoC (a system on chip) that may have been created for the sole purpose of performing mathematical operations. Further, in an embodiment, the arithmetic logic unit (ALU) 210 may receive arguments to be processed through the one or more instructions. A person skilled in the art would appreciate that the processor 202 may include more than one ALUs for performing the predetermined operations of the processor 202 without departing from scope of the disclosure.

The comparator 212 may be configured to compare at least two input signals to generate an output signal. In an embodiment, the output signal may correspond to either ‘1’ or ‘0’. In an embodiment, the comparator 212 may generate output ‘1’ if the value of a first signal (from the at least two signals) is greater than a value of the second signal (from the at least two signals). Similarly, the comparator 212 may generate an output ‘0’ if the value of the first signal is less than the value of the second signal. In an embodiment, the comparator 212 may be realized through either software technologies or hardware technologies known in the art. Though, the comparator 212 is depicted within the processor 202 in FIG. 2, a person skilled in the art would appreciate the comparator 212 may be implemented independent from the processor 202 without departing from the scope of the disclosure.

A person having ordinary skills in the art would understand that the scope of the disclosure is not limited to having a processor 202 to perform one or more operations on the application server 102. In an embodiment, the application server 102 may further include a graph processor (not shown) that may be configured to perform graph related mathematical/logical operations. For example, the graph processor may be configured to create the graph of the one or more entities associated with the organization. Further, the graph processor may further be capable of performing various operations on the graph such as depth first search, breadth first search, spanning through the graph, transforming the graph into a different dimensional space, etc. In an embodiment, the graph processor may be implemented using one or more known technologies such as ASIC, FPGA, SoC, etc. In an embodiment, the graph processor may be coupled to the processor 202.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the processor 202 to perform specific operations. It is apparent to a person with ordinary skills in the art that the one or more instructions stored in the memory 204 enable the hardware of the computing device 200 to perform the predetermined operations.

The transceiver 206 transmits and receives messages and data to/from various components of the system environment 100 (e.g., the hiring manager-computing device 104 and the database server 106) over the network 108. Examples of the transceiver 206 may include, but are not limited to, an antenna, an Ethernet port, a USB port, or any other port that can be configured to receive and transmit data. The transceiver 206 transmits and receives data/messages in accordance with the various communication protocols, such as, TCP/IP, UDP, and 2G, 3G, or 4G communication protocols.

In an embodiment, the display screen 208 may comprise suitable logic, circuitry, interfaces, and/or code that may be operable to render a user interface. In an embodiment, the display screen 208 may be realized through several known technologies, such as, Cathode Ray Tube (CRT) based display, Liquid Crystal Display (LCD), Light Emitting Diode (LED) based display, Organic LED display technology, and Retina display technology. In an alternate embodiment, the display screen 208 may be capable of receiving input from a user. In such a scenario, the display screen 208 may be a touch screen that enables the user to provide input. In an embodiment, the touch screen may correspond to at least one of a resistive touch screen, capacitive touch screen, or a thermal touch screen. In an embodiment, the display screen 208 may receive input through a virtual keypad, a stylus, a gesture, and/or touch based input.

FIG. 3 illustrates a flowchart 300 for selecting the set of candidates for the job opening in the organization, in accordance with at least one embodiment. The flowchart 300 is described in conjunction with FIG. 1 and FIG. 2.

At step 302, a graph, indicative of the relationships between the one or more entities of the organization, is generated. In an embodiment, the processor 202 generates the graph. For creating the graph, the processor 202 may transmit a query to the database server 106 to extract the data pertaining to profiles of the one or more candidates (who have applied for the one or more job openings), profiles of the employees of the organization, and job descriptions associated with the one or more job openings. In an embodiment, the data pertaining to the one or more candidates may include profile of the candidates, and resume submitted by the one or more candidates.

Thereafter, the processor 202 may determine a relationship/similarity between the one or more entities (candidates, employees, and job openings) of the organization. In an embodiment, the processor 202 may extract one or more features from the profiles of the one or more candidates, the profiles of the one or more employees, and the one or more job descriptions associated with the one or more job openings. Based on the one or more features, the processor 202 may determine the relationship between the one or more entities. In an embodiment, the processor 202 may employ natural language processing techniques to extract the one or more features. Thereafter, in an embodiment, the processor 202 may utilize support vector machine (SVM), or any other know feature-mapping technique to determine the relationship between the one or more entities.

For example, a job description of the job openings states, “the candidate must have 2 years of experience in the field of Java programming”. The processor 202 may employ natural language processing technique to extract features such as 2 years work experience and Java programming and skill required. Similarly, the processor 202 may employ natural language processing technique on a candidate profile to determine that the candidate that 3 years of work experience in Java programming field. Further, the processor 202 may determine that the candidate suits the job opening. Thus, the processor 202 in the graph may connect the candidate node and the node corresponding to the job opening. Similarly, the processor 202 may determine the relationship between the other entities of the organization.

A person having ordinary skill in the art would understand that the scope of the disclosure is not limited to determining the relationship between the entities based on the comparison of the respective profiles. In an embodiment, various other parameters may be taken into an account for determining the relationships.

In an embodiment, the processor 202 may determine six types of relationships among the one or more entities. In an embodiment, each of the relationship has one or more associated parameters. Following table illustrates the type of relationships and respective parameters.

TABLE 1
Type of relationships and associated parameters.

| Relationship | Parameters |
|---|---|
| Job Description - Job | Job Description |
| Description | |
| Candidate - Candidate | Candidate Profile, Social Connections |
| Employee - Employee | Employee Profile, Job Affiliation, Social |
| | Connections |
| Job Description - Candidate | Historical Decision, Similarity between |
| | Candidate Profile and Job Description |
| Candidate - Employee | Similarity between Candidate Profile and |
| | Employee Profile, Social Connections |
| Job Description - Employee | Historical Decision, Similarity between |
| | Employee Profile and Job Description |

Based on the determined relationship among the one or more entities, the processor 202 may create a graph. In an embodiment, the graph includes one or more nodes and one or more edges connecting the one or more nodes. In an embodiment, the one or more entities are represented by the one or more nodes in the graph, and the relationships between the one or more nodes are represented by the one or more edges.

Additionally, the processor 202 may assign a first score to each of the one or more edges in the graph. In an embodiment, the first score refers to a measure of similarity between two entities connected by the edge. For determining the first score, the processor 202 may receive weights of each of the one or more parameters associated with each of the one or more edges from the hiring manager through the hiring manager-computing device 104. As discussed above, the one or more edges are representative of the relationship between the one or more entities. Further, the relationships may be of six types and each type may have the one or more associated parameters. Therefore, parameters associated with the edge may be determined based on the type of relationship being represented by the edge. In an embodiment, the weights may be indicative of importance of a parameter based on a set of preferences of the hiring manager. For example, weights assigned to the parameters of the employee-employee relationship is [0.4, 0.4, 0.2], then 0.4 weightage is assigned to employee profile, 0.4 weightage is assigned to the job affiliation, and 0.2 weightage is assigned to employees being social with each other. Thereafter, the arithmetic logic unit 210 in the processor 202 may determine the first score by computing weighted sum of the values of the one or more parameters associated with the edge. For example, the first score for an edge connecting an employee with another employee of the organization may be determined by the processor 202 using following equation:

First score (employee-employee)=0.4*Employee Profile+0.4*Job Affiliation+0.2*social (1)

A person having ordinary skill in the art would understand that the values of the one or more parameters are determined at the time of determination of the relationship between the one or more entities of the organization. For example, the processor 202 determines that there exists a relationship between an employee and a candidate, the processor 202 may determine the values of the one or more parameters (i.e., candidate profile, employee profile, and social). Thereafter, based on the value and weights received from the hiring manager, the processor 202 may determine the first score.

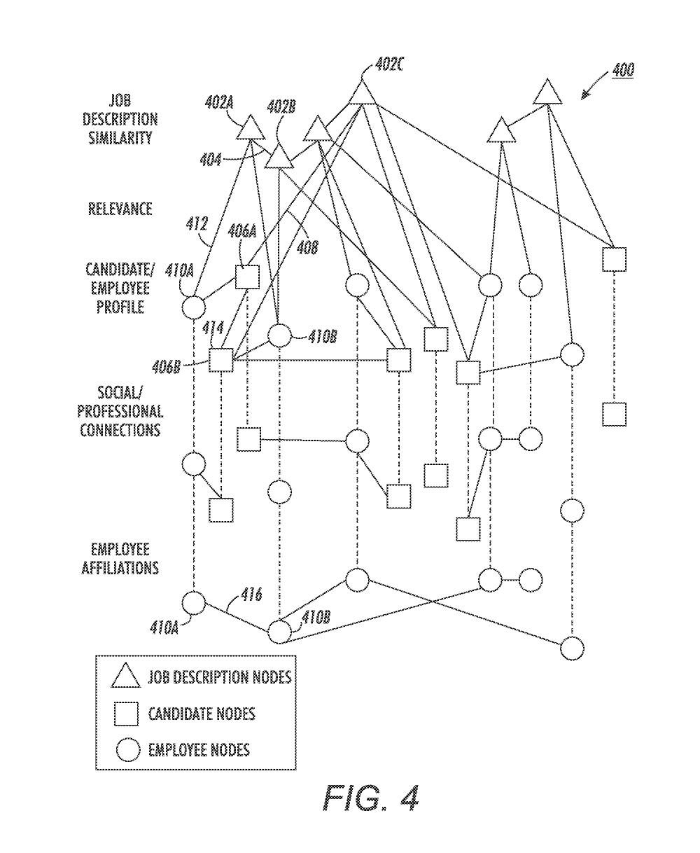

Similarly, the first score is assigned to each of the one or more edges in the graph. An example graph has been described later in conjunction with FIG. 4.

At step 304, the graph is transformed to generate a graph matrix. In an embodiment, the processor 202 transforms the graph. The graph matrix may be representative of a mapping of the one or more nodes in a predetermined dimensional space. In a scenario, the predetermined dimensional space may be a Laplacian embedding space of the graph. In an embodiment, the Laplacian embedding space is a K-dimensional space. In a further embodiment, each node in the graph is mapped to the predetermined dimensional space based on respective K neighboring nodes. In an embodiment, the neighboring nodes may correspond to nodes that are directly or indirectly connected to the node being mapped in the K-dimensional space. In an embodiment, each of the one or more nodes is represented by predetermined non-null Eigen vectors. In an embodiment, the processor 202 may employ Laplacian embedding technique to transform the graph to a K-dimensional graph matrix.

Since the graph matrix is so generated that each node in the graph is represented in the graph matrix based on the K neighboring nodes. The graph matrix may be utilized to identify relationships that are not directly represented in the graph. For example, if there exists a job description 1 (represented as a node in the graph) that is directly connected to job description 2 (represented as a node in the graph) through an edge in the graph. The job description 2 is further connected to job description 3. If such a graph is transformed to generate the graph matrix, the job description 1 will be shown as related to the job description 3 in the graph matrix.

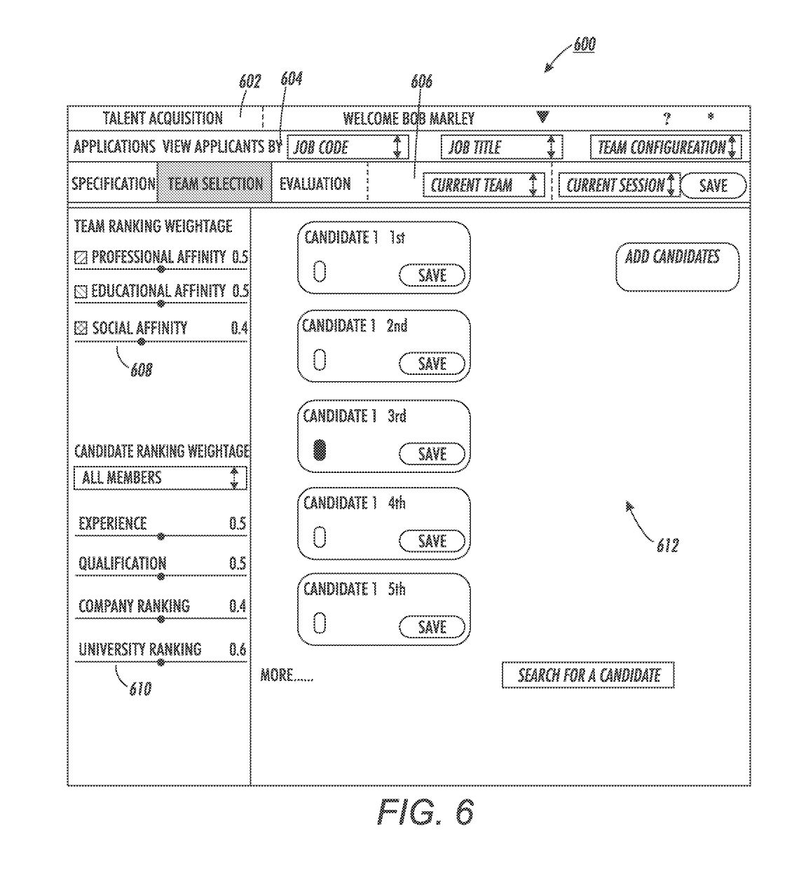

Post generation of the graph matrix, the processor 202 may receive an input from the hiring manager through the hiring manager-computing device 104. In an embodiment, the input may include information pertaining to a job opening for which a set of candidates are to be identified. In an embodiment, the processor 202 may transmit a user interface to the hiring manager-computing device 104 that may enable the hiring manager to provide the input. A sample user interface has been described later in conjunction with FIG. 6.

A person having ordinary skill in the art would understand that the scope of the disclosure is not limited to receiving the input post generation of the graph matrix. In an embodiment, the processor 202 may receive the input from the hiring manager-computing device 104 prior to generation of the graph or prior to the generation of the graph matrix.

At step 306, the arithmetic logic unit 210 in the processor 202, determines the first distance between the first set of nodes and the second node based on the graph matrix. The first set of nodes may correspond to the one or more candidates and the second node may correspond to the job opening (information pertaining to the job opening is received as the input from the hiring manager through the hiring manager-computing device 104). In an embodiment, the processor 202 may determine the distance between the job opening and each of the one or more candidates. In an embodiment, the first distance may correspond to a Euclidean distance in the predetermined dimensional space. In an alternate embodiment, the first distance may correspond to a commute time distance (CTD) in the predetermined dimensional space. In an embodiment, the CTD is inversely proportional to number and lengths of edges connecting two nodes. In an embodiment, accordingly to the CTD, two nodes are strongly connected if there exists multiple paths connecting them. In an embodiment, the CTD is proportional to the Euclidean distance.

At step 308, a set of candidates are selected from the one or more candidates. In an embodiment, the comparator 212 in the processor 202, selects the set of candidates. In an embodiment, the comparator 212 compares the first distance associated with each of the one or more candidates (represented as the first set of nodes in the graph) with a predetermined threshold value. In an embodiment, if the value of the first distance associated with a candidate (represented as the node in the graph) is greater than the predetermined threshold value, the processor 202 may select the respective candidate as the set of candidates. Further, if the value of the first distance is less than the predetermined threshold value, the comparator 212 may reject the candidate for the job opening. Further, the comparator 212 may rank the candidates based on the respective first distance.

A person having ordinary skill in the art would understand that the scope of the disclosure is not limited to selecting the set of candidates from the one or more candidates based on the first distance. In an embodiment, the comparator 212 may just rank the one or more candidates based on the respective first distance associated with each of the one or more candidates.

At step 310, the list of ranked candidates is transmitted to the hiring manager-computing device 104. In an embodiment, the processor 202 may transmit the list of ranked candidates to the hiring manager-computing device 104 through the transceiver 206. The list of ranked candidates may be displayed on the display screen associated with the hiring manager-computing device 104, at step 312.

In a scenario where the complete list of the one or more candidates are sent to the hiring manager-computing device 104, at step 314, an input may be received deterministic of a selection of the set of candidates from the ranked list of the one or more candidates. In an embodiment, the hiring manager may select the set of candidates through a graphical user interface, presented by the processor 202, on the hiring manager-computing device 104.

A person having ordinary skill in the art would understand that the hiring manager may be presented with list of ranked set of candidates (obtained from the step 308). Thereafter, the hiring manager may further prune the list of ranked set of candidates as per the requirements.

FIG. 4 is a graph 400 representing relationships between the one or more entities associated with the organization, in accordance with at least one embodiment.

The graph 400 includes nodes for the one or more job descriptions associated with the one or more job openings, for example, a node 402a (depicted as triangles in the graph 400). Further, the graph 400 includes candidates nodes (depicted as rectangle in the graph 400) and employee nodes (depicted as circles in the graph 400). The one or more nodes are connected with each other through the one or more edges. For example, the job description node 402a is connected to the job description node 402b through the edge 404. Therefore, the job description associated with the job opening (represented by the node 402a) is similar to the job description associated with the job opening ad represented by the node 402b in some aspects.

As discussed above in conjunction with the FIG. 3, the relationships between the one or more candidates and the one or more job descriptions associated with the one or more job openings are determined. Based on the relationships, the processor 202 may connect the nodes corresponding to the one or more candidates with the nodes corresponding to the one or more job descriptions associated with the one or more job openings. For example, the node 402c (representing a job description associated with a job opening) is connected to the node 406a (representing a candidate) through the edge 408. Similarly, the nodes for the one or more job descriptions associated with the one or more job openings may be connected to the nodes for the one or more candidates. For example, the node 402a is connected to the node 410a (representing an employee) through the edge 412. In an embodiment, the edge 412 may depict that the employee 410a has skills that may be required for the job description associated with the job description node 402a. In another embodiment, the edge 412 may depict that the employee 410a may had been recruited in the organization based on the similar job description associated with the job opening as the job description associated with the job opening depicted by 402a.

Further, the graph 400 may further define relationships among the one or more candidates. For example, the candidate 406a may be connected to 406b through the edge 414. In an embodiment, the candidate 406a and the candidate 406b may be acquainted with each other on a social networking platform. Similarly, the graph 400 depicts relationship between the one or more employees. For instance, two employees may have worked together on a project previously. Thus, the processor 202 may connect the nodes of such employees in the graph 400. For example, the node 410a is connected to the node 410b through the edge 416.

Additionally, the graph 400 depicts relationship between the one or more candidates and the one or more employees. For example, an employee may have referred a candidate in the organization for a job opening. In such a scenario, the processor 202 connects the node for the employee with the candidate. In another embodiment, the profiles of the candidate and the employee may be similar. For example, the node 410a is connected to the node 406b through the edge 418.

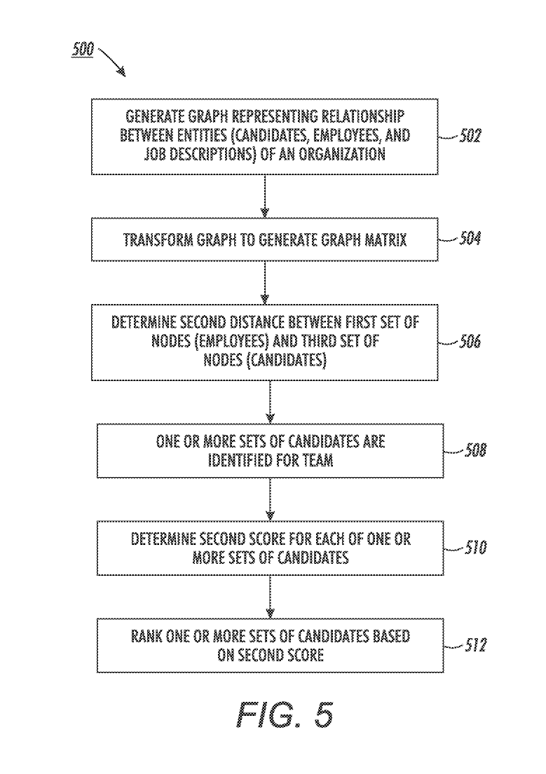

FIG. 5 is a flowchart 500 that illustrates a method for selecting the set of candidates for a team in the organization, in accordance with at least one embodiment. The flowchart 500 is described in conjunction with FIG. 1, FIG. 2, FIG. 3, and FIG. 4.

At step 502, the processor 202 generates the graph representing relationships between the one or more entities. At step 504, the processor 202 generates the graph matrix from the graph.

As discussed above in conjunction with the FIG. 3, an input is received from the hiring manager through the hiring manager-computing device 104. In an embodiment, the input may correspond to the job opening and the team for which the candidate is to be hired. In an embodiment, the input may further include the information pertaining to the size of the team.

At step 506, the arithmetic logic unit 210 in the processor 202, determines the second distance between the first set of nodes (depicting the one or more candidates), each of a third set of nodes (depicting the employees in the team), based on the graph matrix. In an embodiment, the one or more employees correspond to team members of the team for which the one or more candidates are being considered. In an embodiment, the second distance may correspond to a Euclidean distance between the first set of nodes and between each of the first set of nodes and each of a third set of nodes in the predetermined dimensional space. In another embodiment, the second distance corresponds to CTD.

Additionally, the arithmetic logic unit 210 may further determine the first distance between the node (representing the job opening) and the one or more candidates (as discussed in the step 306). Further, processor 202 may select the set of candidates suitable for the job opening as discussed in the step 308. Thereafter, for set of candidates, the arithmetic logic unit 210 may determine the second distance.

At step 508, one or more sets of candidates are identified for the team, based on the team size. In an embodiment, the processor 202 may identify the one or more sets of candidates. For example, the team size inputted by the hiring manager is five. Currently there are two employees already working in the team. Therefore, the processor 202 may group the one or more candidates in sets of three. For instance, there are 10 candidates. Therefore, total number of one or more sets of candidates is ¹⁰C₃.

At step 510, a second score is determined for each of the one or more sets of candidates. In an embodiment, the arithmetic logic unit 210 in the processor 202, determines the second score. In an embodiment, the processor 202 may utilize following equations to determine the second score:

$$\begin{matrix}mean ( {t}_{i} ) = \frac{1}{m} {\sum }_{j} {x}_{α ( i , j )} & ( 2 ) \\ sd ( {t}_{i} ) = \sqrt{\frac{{\sum }_{j} {dist ( {x}_{α ( i , j )} - mean ( {t}_{i} ) )}^{2}}{m}} & ( 3 ) \\ avg\_dist ( {t}_{i} ) = \frac{1}{{m}^{2}} {\sum }_{l = 1}^{m} {\sum }_{j = 1}^{m} dist ( {x}_{α ( i , l )} - {x}_{α ( i , j )} ) & ( 4 ) \\ second score ( {t}_{i} ) = [ \begin{matrix}sd ( {t}_{i} ) \\ avg\_dist ( {t}_{i} )\end{matrix} ] & ( 5 )\end{matrix}$$

where,

x_{α(i,j)}: one or more sets of candidates or team configurations;

i: index for teams;

j: index for candidates in the team;

mean(tᵢ): Mean of second distance associated with candidates in the one or more sets of candidates or team;

sd(tᵢ): Standard deviation of the second distance for a team;

m: size of the team; and

avg_dist(tᵢ): Average of the second distance associated with the candidates.

At step 512, the comparator 212 in the processor 202, based on the second score, ranks the one or more sets of candidates or team configurations. The processor 202 may transmit, to the hiring manager-computing device 104, a list of ranked one or more sets of candidates, at step 516. In an embodiment, the list of ranked one or more sets of candidates is presented to the hiring manager over the display associated with the hiring manager-computing device 104. Further, based on the ranking, at step 520, the processor 202 may receive an input deterministic of a selection of the set of candidates from the ranked list of the one or more sets of candidates for the team from the hiring manager through the hiring manager-computing device 104. In an embodiment, the processor 202 may select the set of candidates from the ranked one or more sets of candidates for the team. In an embodiment, the hiring manager may select the set of candidates through a graphical user interface, presented by the processor 202, on the hiring manager-computing device 104. The information about the selection of the set of candidates may be received by the processor 202.

FIG. 6 is a depiction of a graphical user interface 600 for selecting the set of candidates for the team in the organization, in accordance with at least one embodiment. The graphical user interface 600 is divided into one or more portions including a first portion 602, a second portion 604, a third portion 606, a fourth portion 608, a fifth portion 610, and a sixth portion 612. The graphical user interface 600 is described in conjunction with FIG. 1, FIG. 2, FIG. 3, FIG. 4, and FIG. 5. For the purpose of ongoing description, the graphical user interface 600 shown in FIG. 6 is considered as the graphical user interface being presented on the display screen of the hiring manager-computing device 104, associated with the hiring manager, by the application server 102.

In an example, the application server 102 presents the graphical user interface (GUI) 600 on the display screen of the hiring manager-computing device 104 associated with the hiring manager, for selecting the set of candidates for the team. In an embodiment, the first portion 602 of the graphical user interface (GUI) 600 displays the information about the hiring manager. The second portion 604 includes one or more drop down menus that may enable the hiring manager to select the job opening for which the set of candidates are to be selected. For instance, the hiring manager may utilize the drop down menu corresponding to “job code” and “job title” to select the job opening. Further, the first portion 602 includes the drop down menu corresponding to “team configuration” that may be utilized to select the number of team members.

Further, the graphical user interface 600 includes the third portion 606 that may be utilized to select the team for which the one or more candidates are to be selected. The sixth portion 612 of the graphical user interface 600 is used for presenting the list of ranked candidates. For example, the candidate 1 has been ranked 1 among the remaining set of candidates. The fifth portion 610 presents one or more filters to the hiring manager. The one or more filters may be tuned to modify the ranked list of candidates as per a set of preferences of the hiring manager. For instance, one of the filter presented to the hiring manager is experience. The hiring manager may provide input to slide the experience seek bar to vary the weightage given to the experience. According to the weightage, the processor 202 varies the rank of the candidates in the list of ranked candidates.

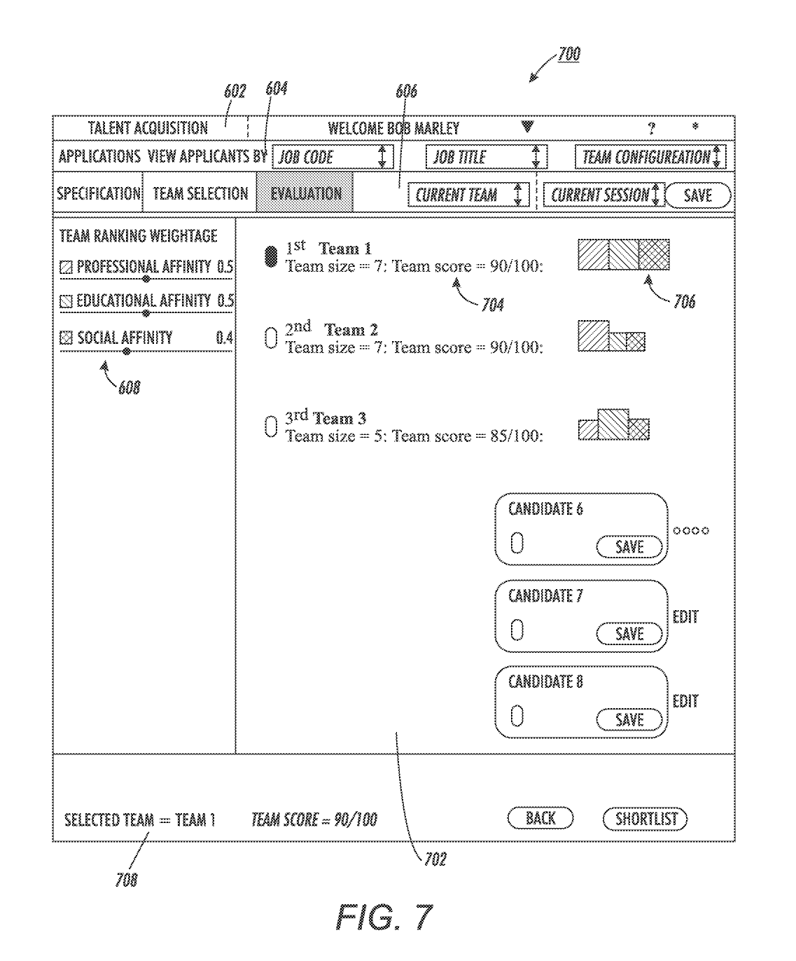

FIG. 7 is the graphical user interface 700, in accordance with at least one embodiment. The graphical user interface 700 is described in conjunction with FIG. 1, FIG. 2, FIG. 3, FIG. 4, FIG. 5, and FIG. 6.

The graphical user interface 700 includes a first portion 702 that is used for displaying one or more sets of candidates. In an embodiment, the one or more sets of candidates correspond to different team configurations. For instance, the team 1 (depicted by a second portion 704) is ranked highest among the remaining teams listed in the first portion 702. In an embodiment, the second score assigned to the team 1 (depicted by the second portion 704) is 90. As discussed above, the second score is representative of the affinity score. Further, the first portion 702 includes a bar chart or a graph (depicted by a third portion 706) that is representative of professional affinity among the one or more candidates and the one or more employees, educational affinity among the one or more candidates, and social affinity among the one or more candidates. In addition, a fourth portion 708 depicts information about the selected team and corresponding team score.

Further, the graphical user interface 700 includes the fourth portion 608 that is used for varying the weightage of each of the professional weightage, educational affinity and the social affinity. Based on the weightage, the rank of the team configuration may be varied by the processor 202.

A person having ordinary skill in the art would understand that the hiring manager may utilize the graphical user interface 700 to create a team configuration such that each team member may have different expertise. In such a scenario, the processor 202 may determine a Euclidean distance between the one or more candidates (having different expertise). Thereafter, based on the distance, the teams are proposed to the hiring manager.

The disclosed embodiments encompass numerous advantages. Through various embodiments of the methods and systems for managing human resources, it is disclosed that hiring of candidates for a team in an organization involves determining relationship among employees, job openings, and candidates who have applied for the job openings. Determining affinity between jobs, candidates, and employees may help in hiring of suitable candidates for the job who may be compatible to the existing employees. Further, the candidates so hired may feel motivated to work in the organization as they may share common characteristics/hobbies with the already existing employees in the organization. Further, possibility of expectation mismatch of the candidate may be reduced.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for managing human resources in an organization have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A human resource management system, said human resource management system comprising:
one or more processors configured to:
generate a graph representative of at least a relationship between one or more entities corresponding to one or more employees associated with an organization, one or more job descriptions associated with one or more job openings in said organization, and one or more candidates for said one or more job openings, wherein said one or more entities are depicted as one or more nodes in said graph;
transform said graph to generate a graph matrix deterministic of at least a mapping of each of said one or more nodes in a predetermined dimensional space;
determine a first distance between a first set of nodes, corresponding to said one or more candidates, from said one or more nodes, and a second node, corresponding to a job description associated with a job opening from said one or more job openings, from said one or more nodes, based on said graph matrix;
rank said one or more candidates based on said first distance; and
a transceiver configured to transmit a list of said ranked one or more candidates to a computing device, wherein said computing device presents said ranked list of candidates over a display associated with said computing device.

2. The human resource management system of claim 1, wherein said relationship between said one or more nodes comprises a relationship between said one or more employees, said one or more candidates, said one or more job openings, said one or more employees and said one or more candidates, said one or more employees and said one or more job openings, and said one or more candidates and said one or more job openings.

3. The human resource management system of claim 1, wherein said graph further comprises one or more edges connecting said one or more nodes.

4. The human resource management system of claim 3, wherein an arithmetic logic unit in said one or more processors, is configured to determine at least a first score for said one or more edges, wherein said first score is indicative of at least a measure of degree of relationship between said one or more nodes.

5. The human resource management system of claim 4, wherein said one or more edges have one or more associated parameters.

6. The human resource management system of claim 5, wherein said one or more processors are further configured to assign one or more first weights to each of said one or more parameters.

7. The human resource management system of claim 6, wherein said arithmetic logic unit is configured to determine said first score for each of said one or more edges based on said one or more first weights assigned to each of said one or more parameters associated with each of said one or more edges.

8. The human resource management system of claim 1, wherein said predetermined dimensional space corresponds to Laplacian embedding space of said graph.

9. The human resource management system of claim 8, wherein said first distance corresponds to a Euclidean distance in said Laplacian embedding space.

10. The human resource management system of claim 1, wherein said one or more processors are further configured to determine a second distance between said one or more candidates and between each of said one or more candidates and each of said one or more employees.

11. The human resource management system of claim 10, wherein said transceiver is further configured to receive an input deterministic of a size of a team, wherein said team includes at least one employee from said one or more employees.

12. The human resource management system of claim 11, wherein said one or more processors are further configured to identify one or more sets of candidates based on said size of said team.

13. The human resource management system of claim 12, wherein said one or more processors are further configured to determine a second score for each of said one or more sets of candidates based on at least said second distance.

14. The human resource management system of claim 13, wherein said transceiver transmits a list of said one or more sets of candidates to said computing device, wherein said computing device presents said ranked list of said one or more sets of candidates over said display associated with said computing device.

15. A method for selecting a set of candidates for a job opening in an organization, said method comprising:
generating, by one or more processors, a graph representative of at least a relationship between one or more entities associated with said organization, wherein said one or more entities correspond to one or more employees, one or more job descriptions associated with one or more openings in said organization, and one or more candidates for said one or more job openings, wherein said one or more entities are depicted as one or more nodes in said graph;
transforming, by said one or more processors, said graph to generate a graph matrix, wherein said graph matrix is deterministic of at least a mapping of each of said one or more nodes in a predetermined dimensional space;
determining, by an arithmetic logic unit in said one or more processors, a first distance between a first set of nodes, corresponding to said one or more candidates, from said one or more nodes, and a second node, corresponding to said job opening from said one or more job openings, from said one or more nodes, based on said graph matrix;
ranking, by said one or more processors, said one or more candidates based on said first distance;
transmitting, by a transceiver, a list of said ranked one or more candidates to a computing device, wherein said computing device presents said ranked list of candidates over a display associated with said computing device; and
receiving, by said transceiver, an input deterministic of selection of said set of candidates from said list of ranked one or more candidates.

16. The method of claim 15, wherein said graph comprises one or more edges connecting said one or more nodes.

17. The method of claim 16, comprising determining, by an arithmetic logic unit in said one or more processors, at least a first score for said one or more edges, wherein said first score is indicative of at least a measure of degree of relationship between said one or more nodes.

18. The method of claim 17 further comprising assigning, by said one or more processors, one or more first weights to each of one or more parameters associated with said one or more edges.

19. The method of claim 18, comprising determining, by said arithmetic logic unit in said one or more processors, said first score for each of said one or more edges based on said one or more first weights assigned to each of said one or more parameters associated with each of said one or more edges.

20. A method for selecting a set of candidates for a team in an organization, said method comprising:
generating, by one or more processors, a graph representative of at least a relationship between one or more entities associated with said organization, wherein said one or more entities correspond to one or more employees, one or more job descriptions associated with one or more job openings in said organization, and one or more candidates for said one or more job openings, wherein said one or more entities are depicted as one or more nodes in said graph;
transforming, by said one or more processors, said graph to generate a graph matrix, wherein said graph matrix is deterministic of at least a mapping of each of said one or more nodes in a predetermined dimensional space;
determining, by an arithmetic logic unit in said one or more processors, a second distance between a first set of nodes, corresponding to said one or more candidates, from said one or more nodes, and between each of said first set of nodes and each of third set of nodes from said one or more nodes, wherein said third set of nodes corresponds to said one or more employees;
receiving, by a transceiver, an input deterministic of a size of said team, wherein said team includes at least one employee from said one or more employees;
identifying one or more sets of candidates based on said size of said team;
determining, by said arithmetic logic unit in said one or more processors, a second score for each of said one or more sets of candidates based on at least said second distance;
transmitting, by said transceiver, a list of ranked said one or more sets of candidates to a computing device, wherein said computing device presents a ranked list of said one or more sets of candidates for said team, based on said second distance, over a display associated with said computing device; and
receiving, by said transceiver, an input deterministic of selection of said set of candidates from said ranked list of said one or more sets of candidates for said team.

21. A computer program product for use with a computer, said computer program product comprising a non-transitory computer readable medium, wherein said non-transitory computer readable medium stores a computer program code for determining incentives for sharing one or more computational resources in a network, wherein said computer program code is executable by one or more processors to:
generate a graph representative of at least a relationship between one or more entities corresponding to one or more employees associated with an organization, one or more job descriptions associated with one or more job openings in said organization, and one or more candidates for said one or more job openings, wherein said one or more entities are depicted as one or more nodes in said graph;
transform said graph to generate a graph matrix deterministic of at least a mapping of each of said one or more nodes in a predetermined dimensional space;
determine a first distance between a first set of nodes, corresponding to said one or more candidates, from said one or more nodes, and a second node, corresponding to a job opening from said one or more job openings, from said one or more nodes, based on said graph matrix; and
rank said one or more candidates based on said first distance.
